(19) United States
(12) Patent Application Publication
(10) Pub. No.: US 2017/0167341 A1
(43) Pub. Date: Jun. 15, 2017

(54) SYSTEM AND METHOD FOR EMISSION CONTROL IN POWER PLANTS

(71) Applicant: General Electric Company, Schenectady, NY (US)

(72) Inventors: Sidharth ABROL, Bangalore (IN); Sangeeta BALRAM, Bangalore (IN); Prem Kumar PATCHAIKANI, Bangalore (IN)

(21) Appl. No.: 15/367,764

(22) Filed: Dec. 2, 2016

(30) Foreign Application Priority Data
Dec. 10, 2015 (IN) 6606/CHE/2015

(51) Int. Cl. F01N 3/20; G05B 13/04; F01N 11/00

(52) U.S. Cl. CPC F01N 3/208; F01N 11/002; G05B 13/042; F01N 2390/02

(57) ABSTRACT

A method of emission control includes receiving a slip set-point and a residual set-point corresponding to a reductant from a selective catalyst reduction (SCR) reactor. The method further includes receiving a plurality of inlet parameters of the SCR reactor and a slip value corresponding to the reductant from outlet of the SCR reactor. The method also includes generating a feedback signal value and a feedforward signal using a gain scheduling approach. The feedback signal is determined based on the slip set-point and the slip value. The feedforward signal value is determined based on a residual value of the reductant and the plurality of inlet parameters using a time-varying kinetic model. The method further includes determining a flow set-point corresponding to the reductant based on the feedback signal value and the feedforward signal value and regulating injection of the reductant into the SCR reactor based on the flow set-point.

### BACKGROUND

The invention relates generally to systems for emission control in power plants, and more particularly to systems for controlling flow of reductant to control emissions in the power plants.

Industrial emanations such as nitrogen oxides and sulphur dioxide create environment pollution. Environment pollution is regulated in most industries. Stringent regulation requirements are being adopted by governments and standard bodies in order to minimize the discharge of noxious gases into the atmosphere by industrial facilities.

Analysis of emanations from exhaust is performed to determine the amount of emissions for the purpose of complying with the regulation requirements. Emission analysis may be performed continuously by using a gas analyzer installed in the exhaust stack. Alternatively, the emission analysis may be performed using the gas analyzer connected to the exhaust stack through an extractive system. However, continuous analysis is expensive due to installation cost, maintenance and calibration requirements. A computer based model may be used to predict emissions such as nitrogen oxide (NOx) emission in order to reduce the cost of analysis of emanations. A number of predictive parameters associated with the fuel conversion process such as temperature, pressure, are used by the computer based model to determine an estimate of the amount of the emissions.

Methodologies used in the past include nonlinear statistical, neural network, eigenvalue, stochastic, and other methods of processing the input parameters from available field devices and to predict process emission rates and combustion or process efficiency.

A reduction reactor may be used in the exhaust system of power plant and engine systems to treat emanations to reduce emissions. Specifically, a reductant such as ammonia is injected into the exhaust gas stream entering the reduction reactor to remove emissions such as NOx from the exhaust gas stream. A portion of the injected reductant may remain unreacted with the emissions and may come out of the reduction reactor along with the exhaust gas combined with unreduced emissions.

### BRIEF DESCRIPTION

In accordance with one aspect of present specification, a method of emission control is disclosed. The method includes receiving a slip set-point and a residual set-point corresponding to a reductant from a selective catalyst reduction (SCR) reactor. The method further includes receiving a plurality of inlet parameters of the SCR reactor, wherein the plurality of inlet parameters comprises a concentration of emission gas. The method also includes receiving a slip value corresponding to the reductant from outlet of the SCR reactor. The method includes generating a feedback signal value using a gain scheduling approach based on the slip set-point and the slip value. The method further includes generating a feedforward signal value using a gain scheduling approach based on a residual value of the reductant on a catalyst surface within the SCR reactor and the plurality of inlet parameters using a time-varying kinetic model. The method also includes determining a flow set-point corresponding to the reductant based on the feedback signal value and the feedforward signal value. The method includes regulating injection of the reductant into the SCR reactor based on the flow set-point.

In accordance with another aspect of present specification, a system for emission control is disclosed. The system includes a selective catalyst reduction (SCR) reactor having an inlet, an outlet and a catalyst disposed in the SCR reactor. The system further includes a signal acquisition unit configured to acquire a slip set-point and a residual set-point from the selective catalyst reduction (SCR) reactor and measure a plurality of inlet parameters of the SCR reactor and a slip value from outlet of the SCR reactor. The plurality of inlet parameters comprises a concentration value of emission gas. The system further includes an injector unit coupled to the SCR reactor configured to inject a reductant into the SCR reactor. The system also includes a regulator unit coupled to the signal acquisition unit and the injector unit and configured to generate a feedback signal value using a gain scheduling approach based on the slip set-point and the slip value. The regulator unit is further configured to generate a feedforward signal value using a gain scheduling approach based on a residual value on a catalyst surface within the SCR reactor and the plurality of inlet parameters using a time-varying kinetic model. The regulator unit is also configured to determine a flow set-point based on the feedback signal value and the feedforward signal value. The regulator unit is configured to regulate injection of the reductant into the SCR reactor based on the flow set-point.

In accordance with one aspect of present specification, a non-transitory computer readable medium having a program is disclosed. The program instructs at least one processor to receive a slip set-point and a residual set-point corresponding to a reductant from a selective catalyst reduction (SCR) reactor. The program further instructs the at least one processor to receive a plurality of inlet parameters of the SCR reactor and receive a slip value from outlet of the SCR reactor. The program also instructs the at least one processor to generate a feedback signal value using a gain scheduling approach based on the slip set-point and the slip value. The program instructs the at least one processor to generate a feedforward signal value using a gain scheduling approach based on a residual value on a catalyst surface within the SCR reactor and the plurality of inlet parameters using a time-varying kinetic model. The program further instructs the at least one processor to determine a flow set-point based on the feedback signal value and the feedforward signal value. The program also instructs the at least one processor to regulate injection of the reductant into the SCR reactor based on the flow set-point.

### DRAWINGS

These and other features and aspects of embodiments of the present invention will become better understood when the following detailed description is read with reference to the accompanying drawings in which like characters represent like parts throughout the drawings, wherein:

FIG. 1 is a diagrammatic illustration of a system for emission control in accordance with an exemplary embodiment;

FIG. 2 is a block diagram of a regulator unit used for emission control in accordance with an exemplary embodiment;

FIG. 3A is a graphical illustration depicting scheduling of feedforward gain in accordance with an exemplary embodiment;

FIG. 3B is a graphical illustration depicting scheduling of feedback gain in accordance with an exemplary embodiment;

FIG. 3C is a graphical illustration depicting reduction of emissions in accordance with an exemplary embodiment;

FIG. 3D is a graphical illustration depicting reduction of reductant in accordance with an exemplary embodiment;

FIG. 4 is a block diagram of complimentary filtering technique for estimating slip value in accordance with an exemplary embodiment;

FIG. 5 is a graphical illustration depicting performance improvement in estimating slip value in accordance with an exemplary embodiment; and

FIG. 6 is a flow chart of a method for emission control in accordance with an exemplary embodiment.

### DETAILED DESCRIPTION

Embodiments of methods and systems for emission control in power plants include receiving a slip set-point value and a residual set-point value from a selective catalyst reduction (SCR) reactor and measuring a plurality of inlet parameters of the SCR reactor. A slip value from outlet of the SCR reactor is also measured. A feedback signal value is generated using a time-varying proportional-integral (PI) controller based on the slip set-point and the slip value. A feedforward signal value representative of the reductant on catalyst surface within the SCR reactor is estimated based on the plurality of input parameters using a time-varying kinetic model. A flow set-point is determined based on the feedback signal value and the feedforward signal value. The flow of the reductant into the SCR reactor is regulated based on flow set-point.

The term emission refers to hazardous chemical components present in exhaust emanations such as nitrogen oxide emissions measured in parts per million (ppm). The term Selective Catalytic Reduction (SCR) refers to a chemical reaction that converts nitrogen oxides into diatomic nitrogen, and water with the aid of a catalyst. The term ‘SCR reactor’ refers to a chamber where the selective catalytic reduction reaction occurs. The term ‘reductant’ generally refers to a chemical element or a compound that loses an electron in a chemical reaction to another chemical element, or a compound. The term ‘slip set-point’ refers to a design parameter indicative of a reference amount of reductant that comes out of outlet of the SCR reactor. The term ‘residual set-point’ refers to a design parameter indicative of a reference amount of reductant residual that is deposited on a catalyst within the SCR reactor. The term ‘slip value’ refers to an amount of the reductant at the outlet of the SCR reactor. The term ‘residual value’ refers to an estimated amount of reductant deposited on a catalyst within the SCR reactor. The term ‘reductant estimate’ refers to an estimate of the slip value of the reductant. The term ‘flow set-point’ refers to a reference amount of the reductant to be introduced into the SCR reactor for reduction of nitrogen oxides. The term ‘feedback signal’ refers to a component of the flow set-point corresponding to the slip value. The term ‘feedforward signal’ refers to a component of the flow set-point corresponding to the residual value.

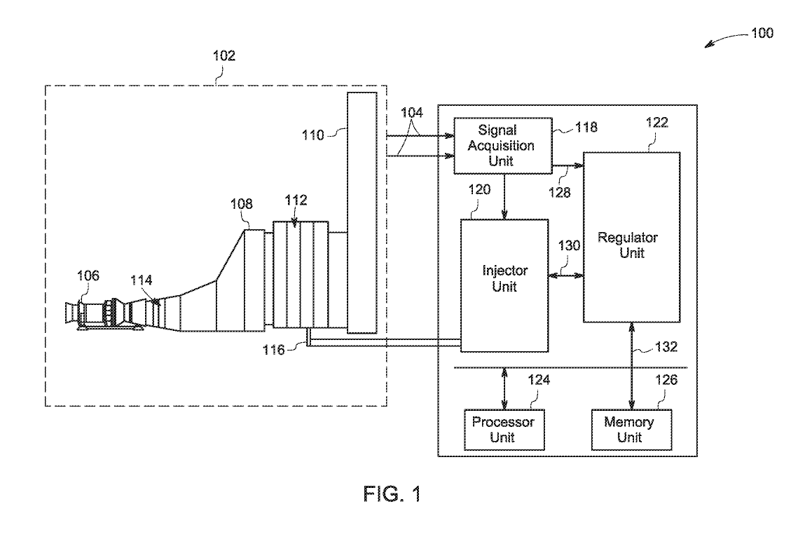

FIG. 1 is a diagrammatic illustration of a system 100 for emission control in accordance with an exemplary embodiment. The emission control system 100 receives a plurality of parameters, represented generally by reference numeral 104, from a power plant 102 and configured to regulate flow of reductant to the system 100 to control emissions from the power plant. The power plant 102 includes a selective catalyst reduction (SCR) reactor 108 coupled to a gas turbine exhaust 106. The SCR reactor 108 includes an inlet 114, an outlet 110 and a catalyst 112 disposed inside the SCR reactor 108. The inlet 114 is configured to receive emanations of the gas turbine exhaust 106. Further, the outlet 110 is configured to release the emanations to the atmosphere after the received emanations have at least in part undergone SCR. The SCR reactor 108 also includes an injector 116 for introducing the reductant into the SCR reactor 108. The reductant interacts with the emanations in the presence of catalyst 112 and reduces the emissions released to the environment. The emission control system 100 includes a signal acquisition unit 118, an injector unit 120, a regulator unit 122, a processor unit 124, and a memory unit 126 interconnected to each other by a communication bus 132.

The signal acquisition unit 118 is communicatively coupled to the power plant 102 and configured to receive the plurality of parameters 104. In one embodiment, the plurality of parameters includes a plurality of inlet parameters and a slip value measured at the outlet of the SCR reactor 108. The plurality of inlet parameters include, but not limited to, ammonia (NH₃), oxygen (O₂), nitrogen monoxide (NO), nitrogen dioxide (NO₂), and combinations thereof. The signal acquisition unit 118 is also configured to retrieve a slip set-point from a predetermined memory location. In one embodiment, the slip set-point is determined by offline experiments and is stored in a memory location accessible by the signal acquisition unit 118.

The injector unit 120 is coupled to the power plant 102 and configured to introduce a reductant into the SCR reactor 108 through the injector 116 in a controlled manner to optimally reduce the emissions from the outlet 110 of the SCR reactor 108. In one embodiment, the injector unit 120 receives a flow set-point value determined based on the plurality of inlet parameters and the slip set-point. The injector unit 120 determines a rate of flow of the reductant into the SCR reactor based on the flow set-point.

The regulator unit 122 is communicatively coupled to the signal acquisition unit 118 and the injector unit 120. Further, the regulator unit 122 is configured to receive a plurality of inlet parameters, and the slip value from the outlet 110. In one embodiment, the regulator unit 122 is configured to receive a reductant measurement from a reductant sensor disposed at the outlet of the SCR reactor 108. However, there is a time delay associated with the reductant measurement from the reductant sensor. Advantageously, a time-varying kinetic model is used to provide an estimate of the reduction slip value based on the reductant measurement. Using the time-varying kinetic model at least in part compensates the effect of a time delay otherwise caused in such measurements. In some embodiments, a feedback gain may be applied by the regulator unit 122 to the slip value provided by the time-varying kinetic model. Further, the regulator unit 122 is configured to estimate a feedforward signal value representative of the reductant on catalyst surface within the SCR reactor based on the plurality of inlet parameters using the time-varying kinetic model. The regulator unit 122 is also configured to generate a feedback signal value using a time-varying proportional-integral (PI) controller based on the slip set-point and the slip value. In one embodiment, a difference between the slip value and the slip set-point to generate a slip difference value. The slip difference value is used to generate the feedback signal. The regulator unit 122 is also configured to determine a flow set-point based on the feedback signal value and the feedforward signal value. In one embodiment, the flow set-point is determined based on the amount of emissions from the outlet of the SCR reactor. In another embodiment, the regulator unit 122 is configured to determine the flow set-point based on a gain value corresponding to the nitrogen oxide emissions. The flow set-point is estimated using a time-varying kinetic model using a complimentary filtering technique. The regulator unit 122 is also configured to regulate the injection of the reductant into the SCR reactor 108 based on the flow set-point.

The regulator unit 122 disclosed herein is configured to determine a trade-off between the amount of emission and the slip value. For a given regulatory specification, the feedforward gain and feedback gains of the regulator unit 122 may be used to maintain both the emissions such as NOx and reductant residual such as ammonia within the acceptable limits. In one embodiment, the feedforward gain and the feedback gains are determined based on a gain scheduling approach. The gain scheduling approach includes determining the feedforward gain and the feedback gain dynamically based on at least one of the amount of emissions at the inlet of the SCR, temperature and flow of emissions at the inlet of the SCR. In some embodiments, the regulator unit 122 is configured to retrieve at least one of the feedback gain and the feedforward gain from a memory. In some of these embodiments, the gain values may be computed apriori based on offline experiments, and subsequently stored in the memory. In other embodiments, at least one of the feedforward gain and the feedback gain are provided by a user.

The processor unit 124 is communicatively coupled to the communication bus 132 and may include at least one arithmetic logic unit, a microprocessor, a general purpose controller or a processor array to perform the desired computations or run the computer program. In one embodiment, functionality of the processor unit 124 may be limited to tasks performed by the signal acquisition unit 118. In another embodiment, the functionality of the processor unit 124 may be dependent upon the functions performed by the injector unit 120. In another embodiment, the functionality of the processor unit 124 may be dependent upon the functions performed by the regulator unit 122. While the processor unit 124 is shown as a single unit, in exemplary embodiments, the emission control system 100 may include two or more processor units. Further, the single or plurality of processor units may have the functionality of one or more of the signal acquisition unit 118, the injector unit 120, and the regulator unit 122. Although the system 100 is shown as a different unit from the power plant 102, in some embodiments, the system 100 may be integrated with the power plant 102.

The memory unit 126 is communicatively coupled to the processor unit 124 and is configured to be accessed by at least one of the units 118, 120 and 122. In an exemplary embodiment, the memory unit 126 may refer to one or more of memory modules. The memory unit 126 may be a non-transitory storage medium. For example, the memory may be a dynamic random access memory (DRAM) device, a static random access memory (SRAM) device, flash memory or other memory devices. In one embodiment, the memory may include a non-volatile memory or similar permanent storage device, media such as a hard disk drive, a floppy disk drive, a compact disc read only memory (CD-ROM) device, a digital versatile disc read only memory (DVD-ROM) device, a digital versatile disc random access memory (DVD-RAM) device, a digital versatile disc rewritable (DVD-RW) device, a flash memory device, or other non-volatile storage devices. In one specific embodiment, a non-transitory computer readable medium may be encoded with a program to instruct at least one processor to perform functions of one or more of the signal acquisition unit 118, the injector unit 120, and the regulator unit 122.

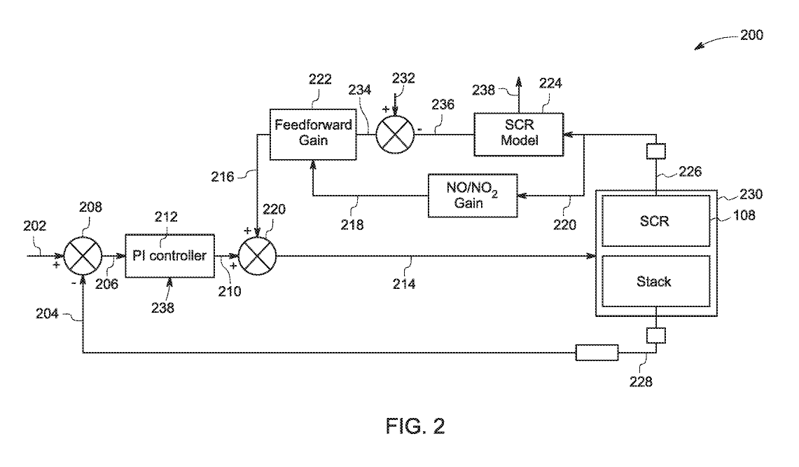

FIG. 2 is a block diagram of the regulator unit 200 used for emission control in accordance with an exemplary embodiment. The regulator unit 200 is configured to receive a reference input 202 that corresponds to reductant slip set-point value. The reductant slip set-point value is provided by the user, or determined based on experimentation and stored in a memory location. In embodiments where the reductant slip set-point is provided by the user, the value may be inserted through a suitable user-interface such as a keyboard, panel, or a touch screen. In embodiments where the reductant slip set-point value is automatically provided, the regulator unit may retrieve the experimentally determined values from the memory location.

The regulator unit 200 is configured to receive a feedback input, generally represented by reference numeral 204. The feedback input is representative of the slip value obtained from measurements. In one embodiment, a measurement value 228 is the reductant measurement representative of slip value obtained from a reductant sensor disposed in the exhaust of the SCR reactor 108. It should be noted that the measurement value 228 is a delayed response of the slip value. In one embodiment, a complimentary filtering technique is applied to the measurement value 228 to obtain the feedback input 204. Specifically, the complimentary filtering generates the feedback input 204 based on a reductant estimate generated by an SCR model 224 representative of the time-varying kinetic model based on the reductant measurement.

In one embodiment, the time-varying kinetic model is a mathematical model representative of chemical reactions that take place in the SCR reactor. In the SCR reactor, ammonia is injected from the injector into the exhaust gas stream and may react, in the presence of the catalyst, with NOx to produce nitrogen (N₂) and water (H₂O). The chemical reactions include, but are not limited to, ammonia adsorption and desorption reaction with the catalyst, ammonia oxidation reaction, standard SCR reaction, fast SCR reaction, NO₂ SCR reaction, and NO oxidation reaction. The mathematical model includes a set of algebraic equations and a set of ordinary differential equations characterizing reactions within the SCR reactor. The set of algebraic equations includes a plurality of rate equations describing characteristics of the individual reactions such as concentration change of each chemical reactant or product. The set of algebraic equations also include equations for catalyst temperature, mass balance equation on ammonia, nitrogen oxide, and nitrogen dioxide. The set of ordinary differential equations include equations for mass balance on ammonia surface coverage. The set of algebraic equations and the set of ordinary differential equations of the mathematical model have the plurality of parameters such as chemical composition and concentration of each chemical reactant or product and the coverage ratio of ammonia on the catalyst.

An error value 206 is generated based on the reference input 202 and the feedback input 204 using a subtractor 208. The subtractor 208 is used to determine a difference value between the reference input 202 and the feedback input 204. A time-varying proportional integral controller 212 is used to generate a feedback signal value 210 based on the error value 206. A feedback gain 238 is applied in the controller 212 while generating the feedback signal value 210. In one embodiment, the SCR model 224 may also generate the feedback gain 238 based on at least one of temperature, flow and amount of emission gas measured at the inlet of the SCR. The feedback signal value 210 is modified by a feedforward signal value 216 to generate a flow set-point 214. In the illustrated embodiment, the feedforward signal value 216 is determined based on a residual error signal 234 generated as a difference between a residual set-point 232 and a residual value 236. It may be noted that the residual value 236 is representative of an amount of reductant deposited on a catalyst of the SCR reactor 230. In one embodiment, the residual value 236 is determined by the SCR model 224 based on a plurality of SCR inlet parameters 226. The plurality of SCR inlet parameters 226 include, but are not limited to flow rate of ammonia (NH₃), percentage concentration of oxygen (O₂), concentration values of emissions measured at the SCR inlet, temperature of a gaseous component at inlet of the SCR (represented by symbol T_{g}), pressure of a gaseous component measured at inlet of SCR (represented by symbol P_{g}), flow of a gaseous component at the inlet of SCR (represented by symbol F_{g}), a ratio of NH₃ to NOx. The concentration values are measured in parts per million (ppm) units. The flow rate is measured in pounds per hour (lb/hr) units. The emissions include nitrogen monoxide (NO) and nitrogen dioxide (NO₂). A feedforward gain 222 is applied to the residual error signal 234 to generate the feedforward signal value 216. The feedforward gain includes a first component corresponding to the residual value 236. Further, the feedforward gain also includes a second component associated with NOx signal 218 corresponding to an amount of emission 220 entering the SCR reactor.

In one embodiment, the complimentary filtering technique compensates the time delay that is inherent in the slip measurement value 228 acquired from the SCR reactor 108. The complimentary filtering disclosed herein is performed using a complimentary filter having a low pass filter circuit coupled to a time delay compensating circuit. In one embodiment, the time delay compensating circuit has a first time constant and the low pass filter circuit has a second time constant matching the first time constant. An output of the low pass is a time delayed signal representative of the slip measurement value 228. In another embodiment, the feedback input 204, representative of the slip value, is determined using a complimentary filtering technique.

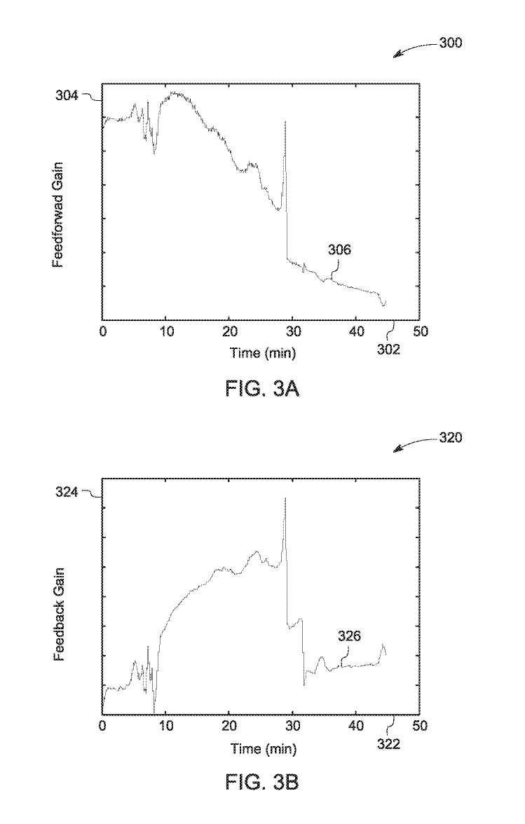

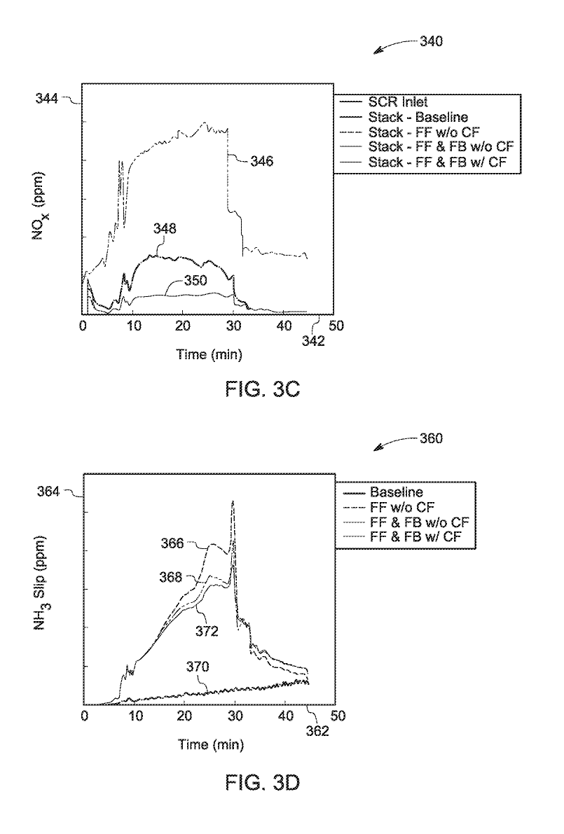

FIG. 3A is a graph 300 illustrating scheduling of feedforward gain in accordance with an exemplary embodiment. The graph 300 includes an x-axis 302 representative of time in minutes and a y-axis 304 representative of feedforward gain. The graph 300 includes a gain scheduling curve 306 representative of time-varying feedforward gain. A time index of zero is representative of beginning of startup of the power plant 102. In one embodiment, the feedforward gain is scheduled as a function of one or more of NO entering the SCR reactor, NO₂ entering the SCR reactor, Fg and Tg. In the illustrated embodiment, the feedforward gain is high during the startup and reaches to a lower value at a later time about thirty minutes after the startup time.

FIG. 3B is a graph 320 illustrating scheduling of feedback gain in accordance with an exemplary embodiment. The graph 320 includes an x-axis 322 representative of time in minutes and a y-axis 324 representative of feedforward gain. The graph 320 includes a gain scheduling curve 326 representative of time-varying feedback gain. A time index of zero is representative of beginning of startup of the power plant 102. In one embodiment, the feedback gain is scheduled as a function of one or more of NO entering the SCR reactor, NO₂ entering the SCR reactor Fg and Tg. In the illustrated embodiment, the feedback gain is low during the startup and reaches to a higher value at a later time about twenty minutes after the startup time before decreasing to a value of twenty at forty minutes. As illustrated, the feedforward gain represented by curve 306 and the feedback gain represented by curve 326 obtained from the gain scheduling approach varies by a factor of eighty over a time period of fifty minutes.

FIG. 3C is a graph 340 illustrating reduction of emissions from the SCR reactor in accordance with an exemplary embodiment. The graph 340 includes an x-axis 342 representative of time and a y-axis 344 representative of an amount of emissions. The graph 340 includes a plurality of curves 346, 348, 350 that are representative of emissions at the inlet of the SCR, a baseline for comparing the emission reduction at the exhaust of the SCR, and the emissions obtained based on the complimentary filtering technique, respectively. As illustrated, the complimentary filtering technique (curve 350) has lower values of emissions compared to the curve 348 representing a baseline performance and the SCR inlet curve 346.

FIG. 3D is a graph 360 illustrating reduction of reductant in accordance with an exemplary embodiment. The graph 360 includes an x-axis 362 representative of time and a y-axis 364 representative of slip values. In the illustrated embodiment, the slip values are measured in parts per million (ppm). The graph 360 includes a plurality of curves 366, 368, 370, and 372, representative of slip values obtained using different techniques. The curve 366 represents slip values obtained using feedforward component without employing complimentary filtering. The curve 368 is representative of slip values obtained using both feedforward component and the feedback component. The curve 370 is representative of slip values corresponding to the curve 348 representing the baseline performance in FIG. 3C. The curve 372 is representative of slip values corresponding to a technique using both feedforward and feedback components determined using complimentary filtering technique. It may be observed that the curves 366, 368, 370 representative of performance obtained from disclosed technique has ability to trade off slip value with the emissions, which may be useful in different regions having varied regulatory requirements.

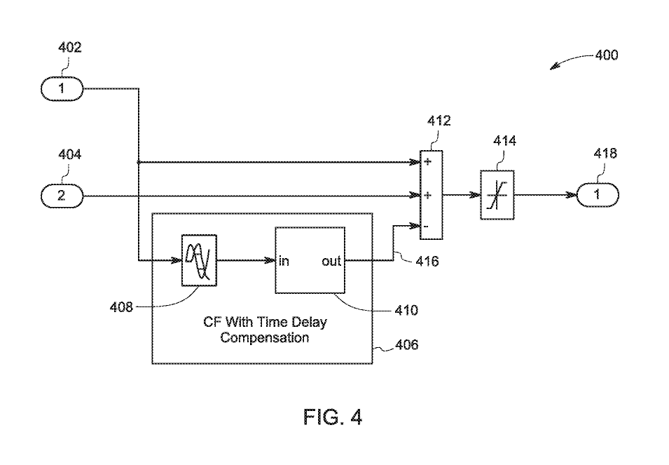

FIG. 4 is a block diagram 400 illustrating complimentary filtering for estimating the slip value in accordance with an exemplary embodiment. A first input 402 corresponding to the reductant estimate is fed to a complimentary filter 406 and an adder 412 in parallel. A second input 404 corresponding to the reductant measurement is fed to the adder 412. The complimentary filter 406 includes a transport delay 408 and a first order lag filter 410. The complimentary filter 406 receives the first input 402 representative of the reductant estimate and generates a complimentary filtered output 416 representative of the time delay compensated version of the reductant estimate. An adder 412 combines the signals corresponding to the first input 402, the second input 404, and subtracts the complimentary filtered output 416. Further, a saturator 414 is used for removal of outlier values in the added signals. An output 418, thus generated by the saturator 414 is an estimate of the slip value.

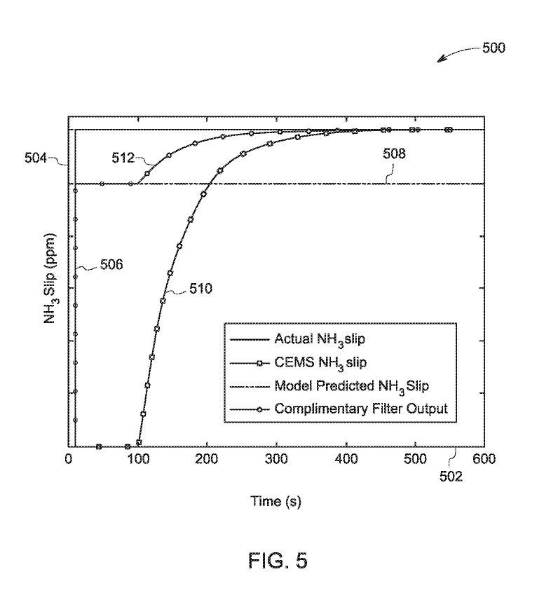

FIG. 5 is a graph 500 illustrating performance improvement in estimating the slip value in accordance with an exemplary embodiment. The graph 500 includes an x-axis 502 representative of time in seconds and a y-axis 504 representative of slip value in parts per millions (ppm). In the illustrated embodiment, the y-axis is representative of ammonia slip value. The graph 500 includes a plurality of curves 506, 508, 510, 512 that are representative of slip values generated from the disclosed embodiments. The curve 506 is representative of actual slip values at the exhaust of the SCR reactor. The curve 508 is representative of an estimated slip value determined using the SCR model. The curve 510 is representative of reductant measurement acquired from a slip sensor at the exhaust of the SCR reactor. The curve 512 is representative of slip value of the reductant determined using a complimentary filtering technique.

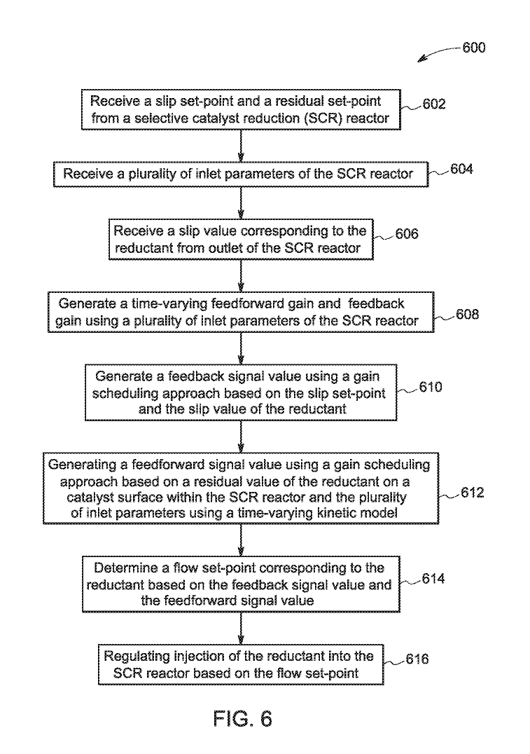

FIG. 6 is a flow chart 600 of a method for emission control in accordance with an exemplary embodiment. The method includes receiving a slip set-point and a residual set-point from a selective catalyst reduction (SCR) reactor as shown in 602. The method further includes measuring a plurality of inlet parameters of the SCR reactor in step 604. The plurality of inlet parameters include, but not limited to, flow rate of ammonia (NH₃), percentage concentration of oxygen (O₂), concentration values of emissions measured at the SCR inlet, temperature of a gaseous component at inlet of the SCR, pressure of a gaseous component measured at inlet of SCR, flow of a gaseous component at the inlet of SCR, a ratio of NH₃ to NOx. The method also includes receiving a slip value from an outlet of the SCR reactor in step 606. The step 606 of receiving the slip value further includes measuring a reductant concentration from a reductant sensor at the outlet of the SCR reactor. Further, the step 606 includes generating an estimate of the slip value from the time-varying kinetic model. The step 606 also includes determining the slip value based on the estimate of the slip value and the reductant measurement using complimentary filtering.

In step 608, a time-varying feedforward gain is determined based on a plurality of inlet parameters of the SCR reactor. Further, in the same step, a feedback gain is also determined based on the plurality of inlet parameters of the SCR reactor. In one embodiment, the feedforward gain and the feedback gains are determined using a gain scheduling approach. In another embodiment, the feedforward gain and the feedback gain are retrieved from the memory. The feedforward gain and the feedback gains are used to simultaneously optimize the emission levels and the slip values at the outlet of the SCR reactor.

A feedback signal value is generated using a time-varying proportional-integral (PI) controller based on the slip set-point and the slip value in step 610. In one embodiment, a gain scheduling approach is used in the PI controller for determining the feedback signal value. The gain scheduling approach includes applying a feedback gain applied to the slip value. In one embodiment, a time-varying feedback gain is determined based on concentration of emission gases, a temperature of exhaust gas, and a flow rate value of the reductant. In step 612, a feedforward signal value representative of the reductant on catalyst surface within the SCR reactor is generated. The generation of feedforward signal value is based on a residual difference value based on a residual value and the residual set-point value. The residual value is estimated by the SCR model and is representative of concentration of reductant on the catalyst surface with the SCR reactor. In one embodiment, a gain scheduling approach is used for determining the feedforward signal value. In one embodiment, a time-varying feedforward gain is determined based on one or more combinations of concentration of emission gases, temperature values of exhaust gases, and the flow rate value of the reductant. In other embodiments, other inlet parameters may also be used to determine the feedforward gain value. In one embodiment, at least one of the feedforward gain and the feedback gain are determined apriori based on offline experiments.

The method also includes determining a flow set-point based on the feedback signal value and the feedforward signal value in step 614. The step 614 of determining the flow set-point includes incorporating an estimate of the amount of emission gas. In step 616, injection of the reductant flow is regulated based on the flow set-point. It should be noted herein that the step 614 determining the flow set-point provides a trade-off between the amount of emission and the slip value. The method of the flow chart 600 also includes regulating injection of the reductant into the SCR reactor based on the flow set-point in step 616

It is to be understood that not necessarily all such objects or advantages described above may be achieved in accordance with any particular embodiment. Thus, for example, those skilled in the art will recognize that the systems and techniques described herein may be embodied or carried out in a manner that achieves or improves one advantage or group of advantages as taught herein without necessarily achieving other objects or advantages as may be taught or suggested herein.

While the technology has been described in detail in connection with only a limited number of embodiments, it should be readily understood that the specification is not limited to such disclosed embodiments. Rather, the technology can be modified to incorporate any number of variations, alterations, substitutions or equivalent arrangements not heretofore described, but which are commensurate with the spirit and scope of the claims. Additionally, while various embodiments of the technology have been described, it is to be understood that aspects of the specification may include only some of the described embodiments. Accordingly, the specification is not to be seen as limited by the foregoing description, but is only limited by the scope of the appended claims.

1. A method of emission control, comprising:
receiving a slip set-point and a residual set-point corresponding to a reductant from a selective catalyst reduction (SCR) reactor;
receiving a plurality of inlet parameters of the SCR reactor, wherein the plurality of inlet parameters comprises a concentration of emission gas;
receiving a slip value corresponding to the reductant from outlet of the SCR reactor;
generating a feedback signal value using a gain scheduling approach based on the slip set-point and the slip value;
generating a feedforward signal value using a gain scheduling approach based on a residual value of the reductant on a catalyst surface within the SCR reactor and the plurality of inlet parameters using a time-varying kinetic model;
determining a flow set-point corresponding to the reductant based on the feedback signal value and the feedforward signal value; and
regulating injection of the reductant into the SCR reactor based on the flow set-point.

2. The method of claim 1, wherein receiving the slip value comprises:
receiving a reductant measurement from a reductant sensor disposed at the outlet of the SCR reactor;
generating a reductant estimate from the time-varying kinetic model; and
determining the slip value based on the reductant estimate and the reductant measurement using complimentary filtering.

3. The method of claim 2, wherein generating the feedback signal value comprises:
determining a difference between the slip value and the slip set-point to generate a slip difference value;
applying a feedback gain to the slip difference value; and
determining the feedback signal value from a proportional-integral (PI) controller based on the slip difference value.

4. The method of claim 3, wherein the feedback gain is determined dynamically based on at least one of the inlet parameters measured at the inlet of SCR reactor.

5. The method of claim 1, wherein the residual value is generated from a time-varying kinetic model.

6. The method of claim 5, wherein generating the feedforward signal value comprises:
determining a residual difference value based on the residual value and a residual set-point value;
applying a feedforward gain to the residual difference value; and
applying the feedforward gain to the residual difference value to generate the feedforward signal value.

7. The method of claim 6, wherein the feedforward gain is determined dynamically based on at least one of the inlet parameters measured at the inlet of SCR reactor.

8. The method of claim 1, wherein the plurality of inlet parameters comprises a concentration value, a flow rate value, a temperature value, and a pressure value of a gaseous component measured at the inlet of SCR reactor.

9. The method of claim 1, wherein determining the flow set-point comprises determining a trade-off between the amount of emission gas and the slip value.

10. A system for emission control, comprising:
a selective catalyst reduction (SCR) reactor having an inlet, an outlet and a catalyst disposed in the SCR reactor;
a signal acquisition unit configured to:
acquire a slip set-point and a residual set-point from the selective catalyst reduction (SCR) reactor; and
measure a plurality of inlet parameters of the SCR reactor and a slip value from outlet of the SCR reactor, wherein the plurality of inlet parameters comprises a concentration value of emission gas;
an injector unit coupled to the SCR reactor configured to inject a reductant into the SCR reactor; and
a regulator unit coupled to the signal acquisition unit and the injector unit and configured to:
generate a feedback signal value using a gain scheduling approach based on the slip set-point and the slip value;
generate a feedforward signal value using a gain scheduling approach based on a residual value on a catalyst surface within the SCR reactor and the plurality of inlet parameters using a time-varying kinetic model;
determine a flow set-point based on the feedback signal value and the feedforward signal value; and
regulate injection of the reductant into the SCR reactor based on the flow set-point.

11. The system of claim 10, wherein the regulator unit is further configured to:
receive a reductant measurement from a reductant sensor disposed at the outlet of the SCR reactor;
generate a reductant estimate generated from the time-varying kinetic model; and
determine the slip value based on the reductant estimate and the reductant measurement using complimentary filtering technique.

12. The system of claim 11, wherein the regulator unit is further configured to:
determine a feedback gain dynamically to the slip value based on at least one of the at least one of the inlet parameters measured at the inlet of the SCR reactor;
determine a slip difference value between the slip value and the slip set-point; and
determine the feedback signal value from a proportional-integral (PI) controller based on the slip difference value.

13. The system of claim 10, wherein the regulator unit is further configured to generate the residual value from a time-varying kinetic model.

14. The system of claim 13, wherein the regulator unit is further configured to:
determine a residual difference value based on the residual value and a residual set-point value;
determine a feedforward gain dynamically based on at least one of the inlet parameters measured at the inlet of the SCR reactor; and
apply the feedforward gain to the residual difference value to generate the feedforward signal value.

15. The system of claim 10, wherein the signal acquisition unit is further configured to receive at least one of a concentration value, a flow rate value, a temperature value, and a pressure value of a gaseous component measured at the inlet of SCR reactor.

16. The system of claim 10, wherein the regulator unit is further configured to determine a trade-off between the concentration value of emission and the slip value.

17. A non-transitory computer readable medium having a program to instruct at least one processor to:
receive a slip set-point and a residual set-point corresponding to a reductant from a selective catalyst reduction (SCR) reactor;
receive a plurality of inlet parameters of the SCR reactor;
receive a slip value from outlet of the SCR reactor;
generate a feedback signal value using a gain scheduling approach based on the slip set-point and the slip value;
generate a feedforward signal value using a gain scheduling approach based on a residual value on a catalyst surface within the SCR reactor and the plurality of inlet parameters using a time-varying kinetic model;
determine a flow set-point based on the feedback signal value and the feedforward signal value; and
regulate injection of the reductant into the SCR reactor based on the flow set-point.
